(19) United States
(12) Patent Application Publication
(10) Pub. No.: US 2007/0116190 A1
(43) Pub. Date: May 24, 2007

(54) System and method of providing access to web-based voice mail for TTY enabled devices

(75) Inventors: Aaron W. Bangor, Austin, TX (US); Jeffrey L. Brandt, Cedar Park, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/251,569

(22) Filed: Oct. 14, 2005

(51) Int. Cl. H04M 11/00; H04M 1/64

(52) U.S. Cl. 379/52; 379/88.01

(57) ABSTRACT

A system and method of providing voice mail is disclosed. The method includes recording a text telephone (TTY) message. Further, the method includes receiving a request for a voice mail message from a web browser and transmitting the TFY message to the web browser.

### FIELD OF THE DISCLOSURE

The present disclosure relates to voice mail systems.

### BACKGROUND

Making voice mail accessible to text telephone/telecommunication device for the deaf (TTY/TDD) users is a challenge. One approach to solving this problem has included taking a typical telephone user interface, which plays spoken language prompts and accepts dual tone multi frequency (DTMF) tones, and reconfiguring that telephone user interface to play TTY prompts and accept TTY responses. As such, a TTY user can retrieve messages that are left using TTY tones.

Recently, web-based voice mail systems have been developed. These systems can allow a user to log into a voice mailbox over the Internet using a web browser. Messages are stored as audio files and the audio files can be downloaded by the user and played with software on the user computer, e.g., Windows Media Player, RealAudio, or Winamp. Alternatively, the audio files can be played using a plug-in or applet that is loaded as part of a web page presented at the user's browser.

Unfortunately, these systems do not accommodate deaf persons that use TTY devices.

### BRIEF DESCRIPTION OF THE DRAWINGS

FIG. 1 is a block diagram that is representative of a communication system; and

FIG. 2 is a flow chart illustrating a method of providing voice mail; FIG. 3 is a flow chart illustrating a method of retrieving voice mail;

FIG. 4 is a flow chart illustrating an alternative method of providing voice mail; and

FIG. 5 is a block diagram that is representative of a general computing system.

### DETAILED DESCRIPTION OF THE DRAWINGS

A method of providing voice mail is disclosed and includes recording a text telephone (TTY) voice mail message. Further, the method includes receiving a request for a voice mail message from a web browser and transmitting the TTY voice mail message to the web browser.

In a particular embodiment, the method includes translating the TTY voice mail message to a text message and transmitting the text message to the web browser. In another particular embodiment, the method includes recording an audio voice mail message and translating the audio voice mail message to a second TTY voice mail message. Moreover, in a particular embodiment, the method can include transmitting the second TTY voice mail message to the web browser.

In yet another particular embodiment, the method includes recording an audio voice mail message, translating the audio voice mail message to a text message, and transmitting the text message to the web browser. Further, in another particular embodiment, the method can include transmitting the audio voice mail message with the text message.

In another embodiment, a method of receiving voice mail is disclosed and includes receiving a TTY voice mail message at a user computer having a web browser and translating the TTY voice mail message to a text message.

In yet another embodiment, a computer system is disclosed and includes a processor, a computer readable medium that is accessible to the processor, and a web browser that is embedded within the computer readable medium. In this embodiment, the web browser includes instructions to receive a TTY voice mail message and instructions to translate the TTY voice mail message to a text message.

In still another embodiment, a voice mail system is disclosed and includes a voice mail server. The voice mail server includes a processor, a computer readable medium that is accessible to the processor, a text telephone (TTY) translation application that is embedded within the computer readable medium. The TTY translation application can include instructions to receive a TTY voice mail message and instructions to transmit the TTY voice mail message to a remote computer.

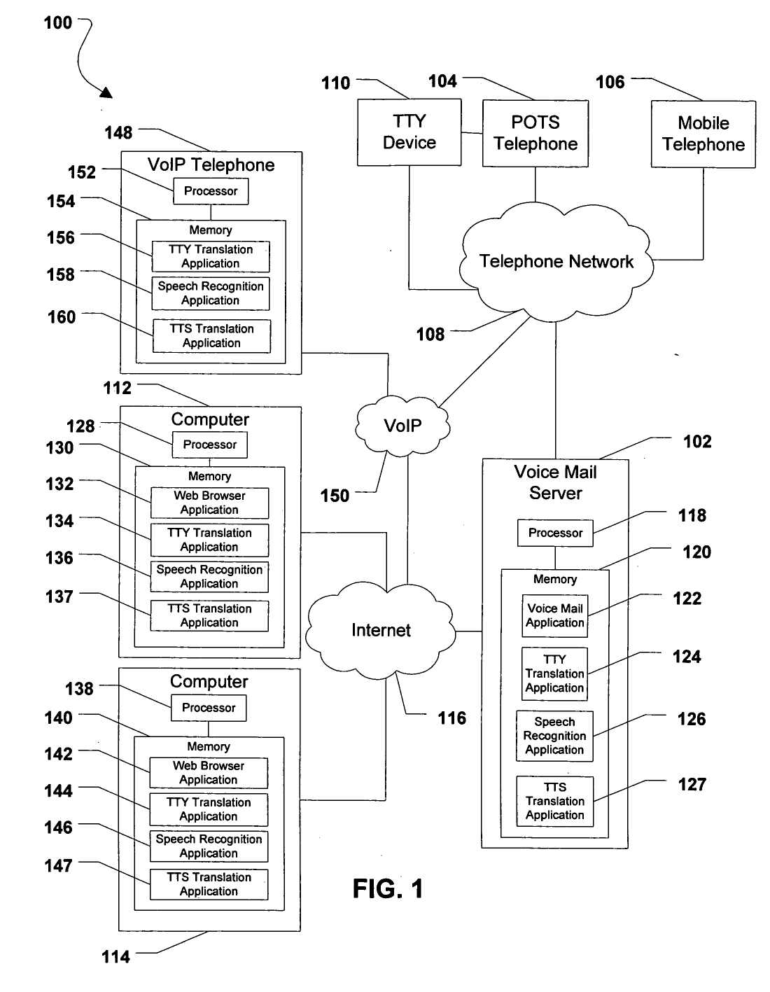

Referring to FIG. 1, a communication system is shown and is generally designated 100. As depicted, the system 100 includes a voice mail server 102 that is coupled to a plain old telephone service (POTS) telephone 104 and a mobile telephone 106 via a telephone network 108. In a particular embodiment, the telephone network 108 is a public switched telephone network or a cellular telephone network. As indicated in FIG. 1, a text telephone (TTY) device 110 can also be coupled to the voice mail server 102 via the telephone network 108. In a particular embodiment, the TTY device 110 can be connected to the POTS telephone 104. In an alternative embodiment, the TTY device 110 may be called a telecommunication device for the deaf (TDD). In a particular embodiment, the TTY device 110 can communicate with other TTY devices using discrete tones that represent the letters of the alphabet.

FIG. 1 also shows that a first user computer 112 and a second user computer 114 can communicate with the voice mail server 102 via a network, e.g., the Internet 116. As illustrated in FIG. 1, the voice mail server 102 includes a processor 118 and a memory 120 that is accessible to the processor 118. Further, a voice mail application 122 can be embedded within the memory 120 of the voice mail server 102. Also, a TTY translation application 124, a speech recognition application 126, and a text-to-speech (TTS) translation application 127 can be embedded within the voice mail server 102.

As illustrated in FIG. 1, the first user computer 112 includes a processor 128 and a memory 130 that is accessible to the processor 128. A web browser application 132, a TTY translation application 134, a speech recognition application 136, and a TTS translation application 137 can be embedded within the memory 130 of the first user computer 112. Additionally, as shown in FIG. 1, the second user computer 114 includes a processor 138 and a memory 140 that is accessible to the processor 138. A web browser application 142, a TTY translation application 144, a speech recognition application 146, and a TTS translation application 147 can be embedded within the memory 140 of the second user computer 114.

FIG. 1 further illustrates a voice over Internet protocol (VOIP) telephone 148 that is coupled to the Internet 116 and the telephone network 108 via a VolP network 150. In a particular embodiment, as depicted in FIG. 1, the VolP telephone 148 can include a processor 152 and a memory 154 that is accessible to the processor 152. Moreover, a TTY translation application 156, a speech recognition application 158, and a TTS translation application can be embedded within the memory 154 of the VolP telephone 148.

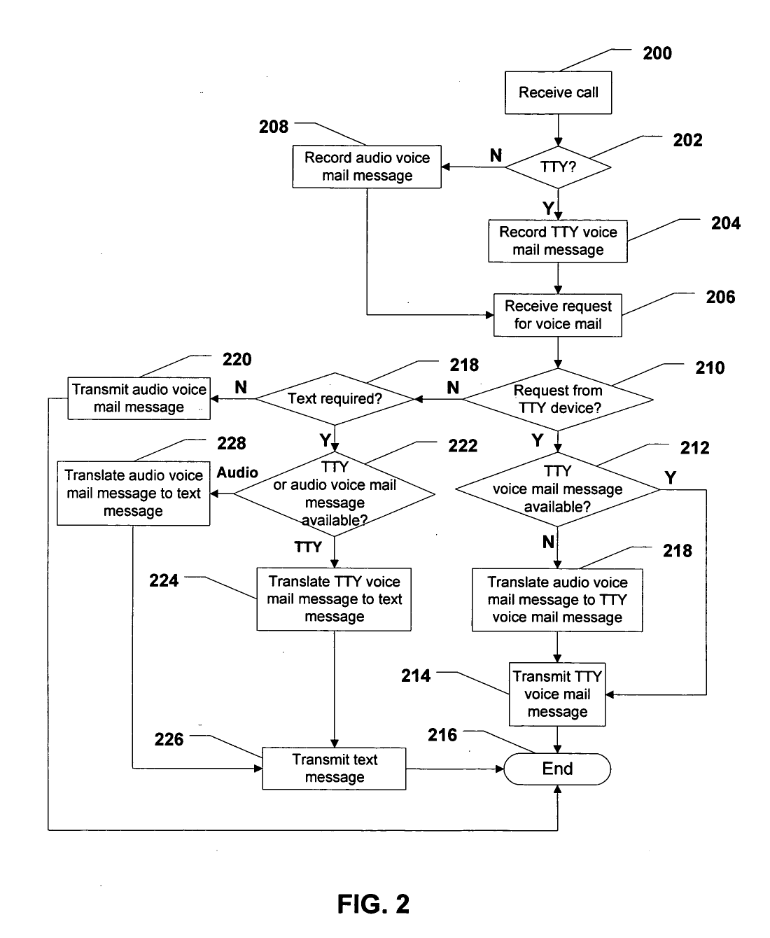

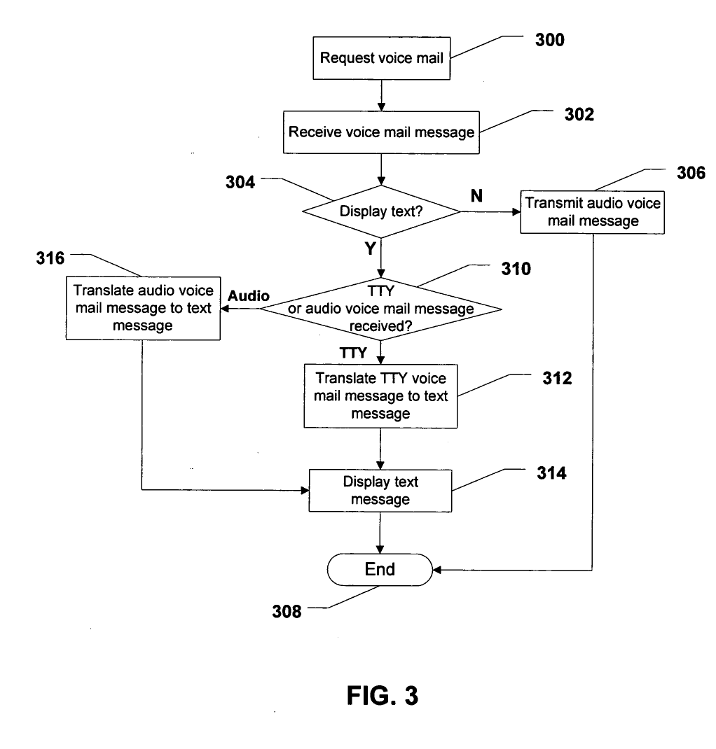

Referring to FIG. 2, a method of providing voice mail is shown and commences at block 200. In a particular embodiment, one or more of the method steps depicted in FIG. 2 can be executed by one or more of the applications 122, 124, 126, 127 (FIG. 1) stored within the memory 120 (FIG. 1) of the voice mail server 102 (FIG. 1).

Beginning at block 200, a voice mail server receives a voice mail message, e.g., via a telephone call or directly from a voice mailbox. At decision step 202, the voice mail server determines whether the call is a TTY call. If so, the method proceeds to block 204 and the voice mail server records a TTY voice mail message. The method then proceeds to block 206.

Returning to decision step 202, when the call is not a TTY call, the method continues to block 208 and the voice mail server records an audio voice mail message. Thereafter, the method moves to block 206.

At block 206, the voice mail server receives a request for voice mail from a voice mail user via a remote device, e.g., a computer, a TTY device, or a telephone. Proceeding to decision step 210, the voice mail server determines whether the request is from a TTY device. If so, the method proceeds to decision step 212 and the voice mail server determines whether a TTY voice mail message is available. When a TTY voice mail message is available, the method moves to block 214 and the voice mail server transmits a TTY voice mail message to the TTY device. The method then ends at state 216.

At decision step 212, when a TTY voice mail message is not available, the method continues to block 218 and the voice mail server translates the audio voice mail message to a TTY voice mail message. Thereafter, the voice mail server transmits the TTY voice mail message to the TTY device at block 214 and the method ends at state 216. In a particular embodiment, the voice mail server can translate the audio voice mail message to a TTY voice mail message using speech recognition software. In an alternative embodiment, the audio voice mail message can be translated into a text message and the text message can be translated into a TTY message.

Returning to decision step 210, if the request is not from a TTY device, the method proceeds to decision step 218. At decision step 218, the voice mail server determines whether text is required. If text is not required, the method moves to block 220 and the voice mail server transmits an audio voice mail message to the requesting device. The method then ends at state 216. Conversely, when text is required, the method continues to decision step 222 and the voice mail server determines whether a TTY voice mail message or an audio voice mail message is available.

When a TTY voice mail message is available, the method moves to block 224 and the voice mail server translates the TTY voice mail message to a text message. Next, at block 226, the voice mail server transmits the text message to the requesting device. The method then ends at state 216. At decision step 222, when an audio voice mail message is available, the method moves to block 228 and the voice mail server 228 translates the audio voice mail message to a text message. In a particular embodiment, the translation of audio to text can be performed using a speech recognition application. Moving to block 226, the voice mail server transmits the text message to the requesting device and the method then ends at state 216.

In a particular embodiment, the voice mail server can transmit the audio voice mail message along with the text message. In a particular embodiment, the audio voice mail message and the text message can be transmitted to the requesting device via the Internet. Alternatively, the text message can be transmitted via a short messaging system (SMS). Additionally, the voice mail server can transmit an audio message, a text message, and a TTY message in a single message and the receiving device can determine which message to present to a user.

In a particular embodiment, the voice mail server can translate audio voice mail messages or TTY voice mail messages after receiving a request from a user. Alternatively, the voice mail server can translate audio voice mail messages or TTY voice mail messages on a per user basis.

FIG. 3 depicts a method of retrieving voice mail, e.g., via a web browser at a computer. In a particular embodiment, one or more of the method steps illustrated in FIG. 3 can be performed by the applications 132, 134, 136, 137, 142, 144, 146, 147 (FIG. 1) stored within the memory 130, 140 (FIG. 1) of each computer 112, 114 (FIG. 1). Further, one or more of the method steps can be performed by the applications 156, 158, 160 (FIG. 1) stored within the memory 154 (FIG. 1) of the VolP telephone 148 (FIG. 1).

Commencing at block 300, a user requests voice mail, e.g., at a web browser interface. At block 302, a voice mail message is received at the web browser from a web based voice mail server. Thereafter, at decision step 304, the computer determines whether the voice mail message should be displayed as text. In a particular embodiment, a web browser at the computer can include a setting that a user can select in order to have voice mail messages displayed as text at the web browser.

At decision step 304, when the voice mail message is not designated to be displayed as text, the method continues to block 306 and the computer transmits the audio voice mail message. In a particular embodiment, the computer plays the audio voice mail message and the audio voice mail message is transmitted to a user via one or more speakers coupled to the computer.

At decision step 304, when the voice mail message is designated to be displayed as text, the method proceeds to decision step 310 and the computer determines whether a TTY voice mail message or an audio voice mail message has been received at the web browser of the computer. When a TTY voice mail message is received, the method proceeds to block 312 and the computer translates the TTY voice mail message to a text message. In a particular embodiment, the user computer, e.g., a TTY translation application at the user computer, translates the TTY voice mail message by receiving the TTY tones from the voice mail server and generating a text message that corresponds to the TTY tones. At block 314, the computer displays the text message to the user, e.g., by displaying text on a computer screen. The method then ends at state 308.

Returning to decision step 310, when the voice mail message is an audio voice mail message, the method proceeds to block 316 and the computer, e.g., a speech to text application at the computer, translates the audio voice mail message to a text message. Moving to block 314, the computer displays the text message. Thereafter, the method ends at state 308.

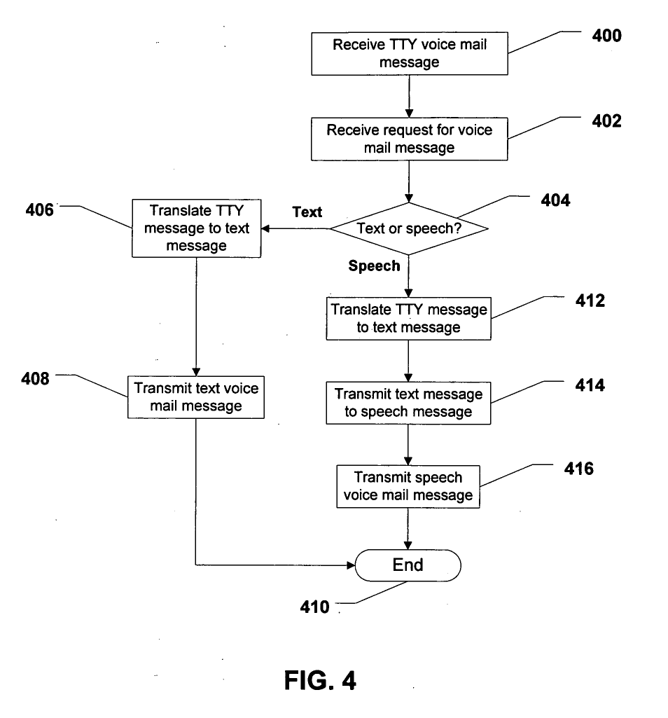

FIG. 4 depicts an alternative method of providing voice mail. In a particular embodiment, one or more of the method steps illustrated in FIG. 4 can be executed by one or more of the applications 122, 124, 126, 127 (FIG. 1) stored within the memory 120 (FIG. 1) of the voice mail server 102 (FIG. 1).

Commencing at block 400, a TTY voice mail message is received, e.g., at a voice mail server. At block 402, the voice mail server receives a request for a voice mail message. At decision step 404, the voice mail server determines whether the request is for text or speech. When the request is for text, the method moves to block 406 and the voice mail server translates the TTY message to a text message. Next, at block 408, the text voice mail message is transmitted to the requesting device. In a particular embodiment, the text voice mail message can be translated using short messaging services (SMS). The method then ends at state 410.

Returning to decision step 404, when the request is for speech, the method proceeds to block 412 and the voice mail server translates the TFY message to a text message. At block 414, the voice mail server translates the text message to a speech message. In an illustrative embodiment, the voice mail server can translate the text message to a speech message using text-to-speech (TTS) logic. Moving to block 416, the voice mail server transmits a speech voice mail message to the requesting device.

In a particular embodiment, the speech voice mail message can be transmitted using a voice channel, e.g., provided by a wireless telephone network, a POTS telephone network, or a VolP network. Then, the method ends at state 410.

In a particular embodiment, the method steps described herein may be performed in the order described. However, in alternative methods, the method steps may be performed in one or more different orders.

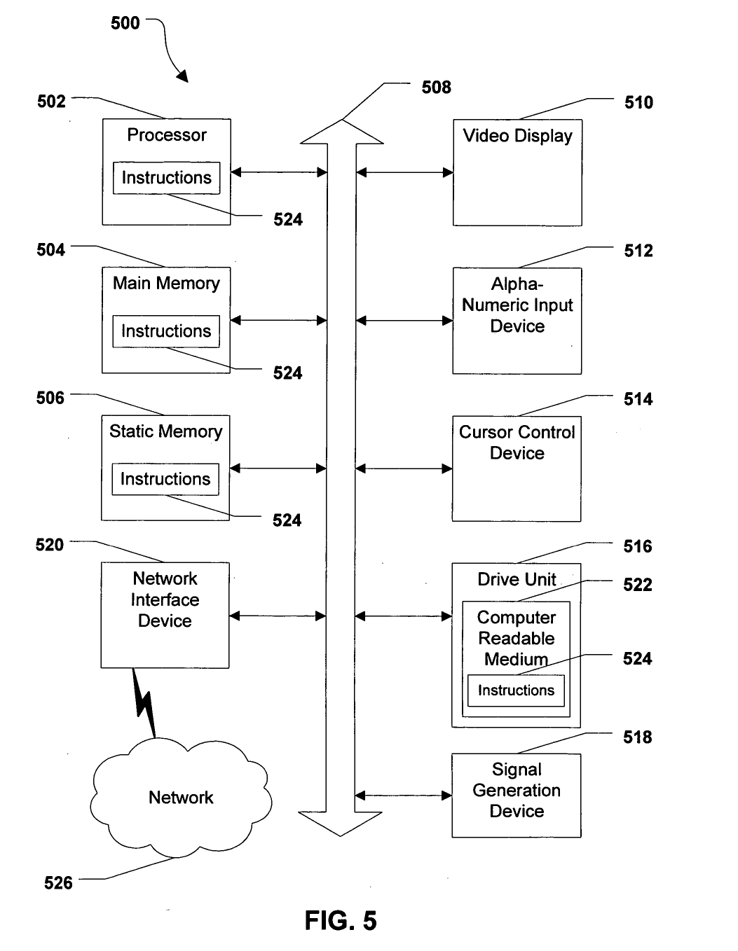

Referring to FIG. 5, an illustrative embodiment of a general computer system is shown and is designated 500. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices. In a particular embodiment, one or more of the components described in conjunction with FIG. 1, e.g., the voice mail server 102, the POTS telephone 104, the mobile telephone 106, the TTY device 1 10, the first computer 1 12, the second computer 1 14, and the VolP telephone 148, can include one or more of the elements described within the computer system 500.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. Moreover, the computer system 500 can include a main memory 504 and a static memory 506 that can communicate with each other via a bus 508. As shown, the computer system 500 may further include a video display unit 510, such as a liquid crystal display (LCD), an organic light emitting diode (OLED), a flat panel display, a solid state display, or a cathode ray tube (CRT). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

With the configuration of structure described above, the system and method of providing access to web-based voice mail for TTY enabled devices provides a way for deaf persons to receive voice mails at a computer. For example, a web browser at a computer can include a TTY translation module that can receive TTY voice mail messages and translate the TrY voice mail messages to text messages. Further, a voice mail server can include a TTY translation module that can translate TTY voice mail messages to text messages and transmit the text messages to one or more web browsers.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing voice mail, the method comprising:
recording a text telephone (TTY) message;
receiving a request for a voice mail message from a web browser; and
transmitting the TTY message to the web browser.

2. The method of claim 1, further comprising:
translating the TTY message to a text message.

3. The method of claim 2, further comprising:
transmitting the text message to the web browser.

4. The method of claim 1, further comprising:
recording an audio message; and
translating the audio message to a second TTY message.

5. The method of claim 4, further comprising:
transmitting the second TTY message to the web browser.

6. The method of claim 1, further comprising:
recording an audio message; and
translating the audio message to a text message.

7. The method of claim 6, further comprising:
transmitting the text message to the web browser.

8. The method of claim 1, further comprising:
recording an audio message;
translating the audio message to a text message; and
transmitting the text message to the web browser.

9. The method of claim 8, further comprising:
transmitting the audio message with the text message.

10. The method of claim 6, further comprising:
transmitting the audio message with the text message and the TTY message.

11. A method of receiving voice mail, the method comprising:
receiving a TTY voice mail message at a user computer having a web browser; and
translating the TTY voice mail message to a text message.

12. The method of claim 1 1, further comprising:
displaying the text message at the user computer.

13. The method claim 11, further comprising:
receiving an audio voice mail message; and
transmitting the audio voice mail message via the web browser.

14. The method of claim 13, further comprising:
translating the audio voice mail message to a text message; and
displaying the text message at the web browser.

15. A computer system, comprising:
a processor;
a computer readable medium accessible to the processor; and
a computer program embedded within the computer readable medium, wherein the computer program comprises:
instructions to receive a TTY voice mail message; and
instructions to translate the TTY voice mail message to a text message.

16. The system of claim 15, wherein the computer program further comprises instructions to display the text message.

17. The system claim 15, wherein the computer program further comprises:
instructions to receive an audio voice mail message; and
instructions to play the audio voice mail message.

18. The system of claim 17, wherein the computer program further comprising:
instructions to translate the audio voice mail message to a second text message; and
instructions to display the second text message.

19. A voice mail system, comprising:
a voice mail server, the voice mail server having:
a processor;
a computer readable medium accessible to the processor; and
a text telephone (TTY) translation application embedded within the computer readable medium, the TTY translation application comprising:
instructions to receive a TTY voice mail message; and
instructions to transmit the TTY voice mail message to a remote computer.

20. The system of claim 19, wherein the TTY translation application further comprises instructions to translate the TTY voice mail message to a text message.

21. The system of claim 20, wherein the TTY translation application further comprises instructions to transmit the text message to the remote computer.

22. The system of claim 19, wherein the TTY translation application further comprises:
instructions to receive an audio voice mail message; and
instructions to translate the audio voice mail message to a second TTY voice mail message.

23. The system of claim 22, wherein the TTY translation application further comprises instructions to transmit the second TTY voice mail message to the remote computer.

24. The system of claim 19, further comprising:
a speech recognition application embedded within the computer readable medium, the speech recognition application comprising:
instructions to record an audio voice mail message;
instructions to translate the audio voice mail message to a text message; and
instructions to transmit the text message to the remote computer.
